(19) United States
(12) Patent Application Publication
(10) Pub. No.: US 2006/0022560 A1
(43) Pub. Date: Feb. 2, 2006

(54) Filing cabinet with a locking system

(76) Inventors: Kevin Ashby, Innisfil (CA); David Parshad, Markham (CA); Ivan Liu, Markham (CA)

Correspondence Address: RICHES, McKENZIE & HERBERT LLP;2 Bloor Street East, Suite 1800, Toronto, ON, M4W 3J5, CA

(21) Appl. No.: 10/969,671

(22) Filed: Oct. 21, 2004

(30) Foreign Application Priority Data
Jul. 28, 2004 (CA) 2475835

(51) Int. Cl. E05B 65/46

(52) U.S. Cl. 312/216

(57) ABSTRACT

An external locking mechanism for a filing cabinet incorporating two hinged blocking plates at each side of the cabinet and a locking bar which is movable without removal from attachment to the cabinet to positions such that the blocking plates can be selectively prevented from being moved to unblocked positions or permitted to be moved to unblocked positions.

### SCOPE OF THE INVENTION

This invention relates to a filing cabinet, and in particular, to a filing cabinet with a locking system.

### BACKGROUND OF THE INVENTION

Filing cabinets are known having drawers that open forwardly to provide access to paper files and the like inside. One example of a filing cabinet structure is shown in U.S. Pat. No. 4,480,883 to Edwards issued Nov. 6, 1984 which is directed to an internal anti-tip blocking device that permits only one drawer of a stacked column of drawers to be opened at any one time.

Filing cabinets are known to have internal lock structures which are internal of the cabinet and prevents any of the drawers from being opened. For added security, it is also known to provide external locking devices with a metal bar which extends vertically across the height of a column of drawers and is secured at the top and bottom of the cabinet to prevent opening of any drawers. Such external bar has the disadvantage that it must be removed and stored when not in use.

### SUMMARY OF THE INVENTION

To at least partially overcome the disadvantages of previously known devices, the present invention provides an external locking mechanism for a filing cabinet incorporating two hinged blocking plates at each side of the cabinet and a locking bar which is movable without removal from attachment to the cabinet to positions such that the blocking plates can be selectively prevented from being moved to unblocked positions or permitted to be moved to unblocked positions.

An object of the present invention is to provide an improved external locking system for a filing cabinet.

Another object of the present invention is to provide a filing cabinet with a locking system which is very simple to use, and also relatively easy and inexpensive to manufacture.

In one aspect, the present invention provides a filing cabinet having a compartment with at least one drawer slidably mounted in the compartment between retracted and withdrawn positions. Blocking plates are hinged to each opposite side of the compartment rotatable on a vertical axis between: (i) a blocked position in the path of the drawer to prevent the drawer from withdrawal from the retracted position; and (ii) an unblocked position out of the path of the drawer to permit withdrawal to the withdrawn position. A locking bar is mounted to the cabinet movable between: (i) a locked position where at least a portion of the locking bar is in the path of both of the blocking plates and prevents each of the blocking plates from movement from the blocked position to the unblocked position; and (ii) unlocked positions where the locking bar is out of the path of the blocking plates and does not prevent the blocking plates from movement from the blocked position to the unblocked position.

In a preferred embodiment, the cabinet has a framework comprising by two opposite sidewalls, a back wall, a top wall, and a bottom wall which define a compartment therein containing sliding drawers and with an opening from the compartment from which the drawers are slidable through the opening.

The framework preferably includes a crossbeam which has ends that are secured to the opposite side walls of the framework preferably to extend horizontally between two drawers and with the locking bar mounted to the crossbeam, preferably for sliding or pivotal movement thereto.

The crossbeam preferably has a forward facing surface and the locking bar is mounted to the forward facing surface of the crossbeam.

In one preferred embodiment, the two opposite side walls each have a forward facing surface. A continuous hinge is mounted to the forward facing surface of the side wall with one hinge plate of the continuous hinge forming or carrying blocking plate.

In another preferred embodiment, the two opposite side walls each have a forward facing gable surface and a continuous hinge is mounted to the gable panel with one hinge plate mounted flush with the gable surface and the other hinge plate of the piano hinge pivotable relative the fixed hinge plate and forming a blocking plate which extends inwardly in front of the drawers.

Preferably, the length of the locking bar is such that it does not extend past the two opposite side walls, regardless of the position of the locking bar.

In an alternative embodiment, the filing cabinet comprises two locking bars mounted at opposite sides of the compartment. Each of the two locking bars is movable between: (i) a locked position where at least a portion of the locking bar is in the path of one of the blocking plates and prevents the blocking plate from movement from the blocked position to the unblocked position; and (ii) an unlocked position where the locking bar is out of the path of the blocking plate and does not prevent the blocking plate from movement from the blocked position to the unblocked position.

### BRIEF DESCRIPTION OF THE DRAWINGS

Further aspects and advantages will become apparent from the following description taken together with the accompanying drawings in which:

FIG. 1 is a front pictorial view of a filing cabinet in accordance with a first embodiment of the present invention showing the drawers closed and locked;

FIGS. 2 to 5 are front pictorial views of a filing cabinet in accordance with the first embodiment of the present invention, wherein the drawers and associated slides have been removed;

FIGS. 6, 8, 10 and 12 are partially cut-away top views of FIGS. 2 to 5, respectively;

FIGS. 7, 9, 11, and 13 are partially cut-away front perspective views of FIGS. 2 to 5, respectively;

FIGS. 14 to 17 are front pictorial views of a filing cabinet in accordance with a second embodiment of the present invention, wherein the drawers and associated slides have been removed;

FIGS. 18 and 20 are partially cut-away top views of FIGS. 14 and 17, respectively;

FIGS. 19 and 21 are partially cut-away front perspective views of FIGS. 14 and 17, respectively;

FIG. 22 is a partially cut-away top view of FIG. 14;

FIG. 23 is a cross-sectional view along section line A-A of FIG. 22;

FIG. 24 is a cross-sectional view along section line B-B of FIG. 22;

FIGS. 25 to 28 are front pictorial views of a filing cabinet in accordance with a third embodiment of the present invention, wherein the drawers and associated slides have been removed;

FIG. 29 is a front view similar to FIG. 1 but unlocked and with one drawer open;

FIG. 30 and 31 are cross-sectional plan views along section lines D-D′ and E-E′ in FIG. 2;

FIGS. 32 and 33 are partially cut-away top views of a fourth embodiment of the present invention;

FIG. 34 is a front pictorial view of a left locking bar in accordance with the fourth embodiment illustrated in FIGS. 32 and 33; and

FIG. 35 is a front pictorial view of a right locking bar in accordance with the fourth embodiment illustrated in FIGS. 32 and 33.

Throughout all the drawings and the disclosure, similar parts are indicated by the same reference numerals.

### DESCRIPTION OF THE PREFERRED EMBODIMENTS

### First Preferred Embodiment

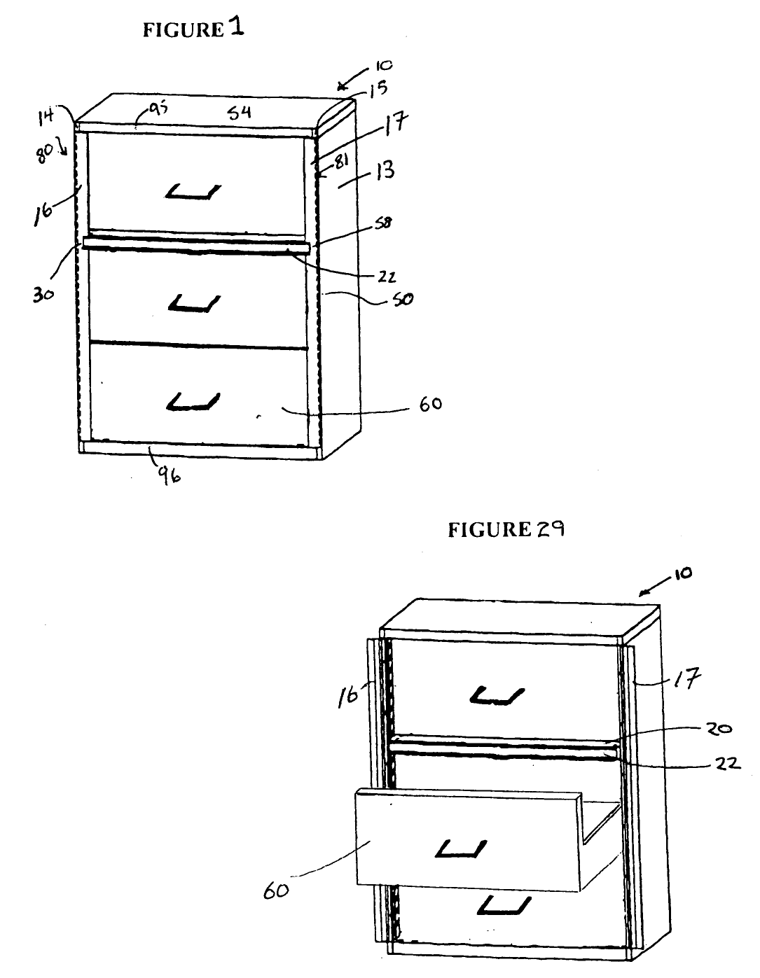

Reference is made to FIGS. 1 to 13 and 29 which illustrate a first embodiment of a filing cabinet in accordance with the present invention.

As seen in FIGS. 1 to 13 and 29 the cabinet 10 has a framework comprising opposite side walls 12 and 13, a back wall 52, a top wall 54 and a bottom wall 56. The framework defines a compartment therein. As seen in FIGS. 1 and 29 three drawers 60 are mounted in the compartment for horizontal sliding between closed, retracted positions shown in FIG. 1 and open, extended positions. FIG. 29 shows a middle of the three vertically stacked drawers in an open, extended position. The drawers 60 are slidable on associated slides (not shown) mounted to the interior of the side walls 12 and 13 on each side of each drawer 60. The framework of the filing cabinet 10 includes a horizontal crossbeam 20. The crossbeam 20 has both of its ends permanently secured to the opposite side walls 12 and 13. The crossbeam 20 extends horizontally between the sidewalls 12 and 13 vertically between two of the drawers 60 and presents a forward facing surface 62 best seen in FIG. 24. Each of sidewalls 12 and 13 carry a forward facing gable surface 14 and 15 effectively forming a gable or post extending vertically beside each drawer 60 throughout the height of the cabinet.

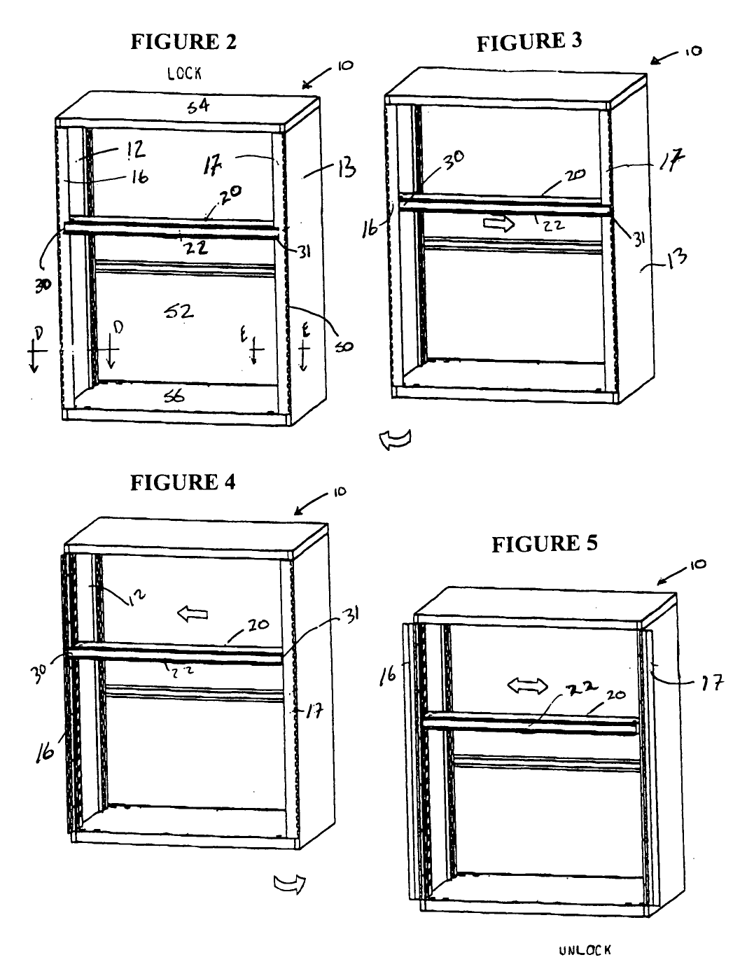

FIGS. 2 to 13 illustrate the filing cabinet 10 of FIGS. 1 and 29 from which the drawers 60 and associated slides have been removed.

As seen in FIG. 30 and 31 two continuous hinges 80 and 81 also known as piano hinges are mounted to the forward facing gable surface 14 and 15 of each side wall 12 and 13. Each hinge 80 and 81 has two hinge plates namely a base plate 82, 83, a blocking plate 16, 17 joined by a hinge pin 84, 85 with the base plate 82, 83 and blocking plate 16, 17 pivotable relative each other about the pin 84, 85. The base plate 82, 83 is fixedly secured to the respective gable surface 14 and 15 of the side walls as by screws, nuts, welding or the like with the hinge pin 84 disposed to not extend laterally beyond the respective side wall 12 and 13. Each blocking plate 16, 17 is thus hinged to its relative side wall 12, 13 for pivoting about the vertical hinge pin 84, 85.

The blocking plates 16, 17 are adapted to be rotatable from: (i) a blocked position, as shown in FIG. 2, 6 and 7, in which the blocking plates 16, 17 lie forward of the drawers 60 in the front plane of the front face of the cabinet 10 to (ii) an unblocked position, as shown in FIG. 5, 12 and 13, in which the blocking plates 16, 17 are rotated to extend forwardly preferably perpendicular to the front face of the cabinet 10 and thus parallel to side walls 12 and 13. FIGS. 30 and 31 show the blocking plates 16, 17 in solid lines in an unblocked position and in dashed lines in a blocked position.

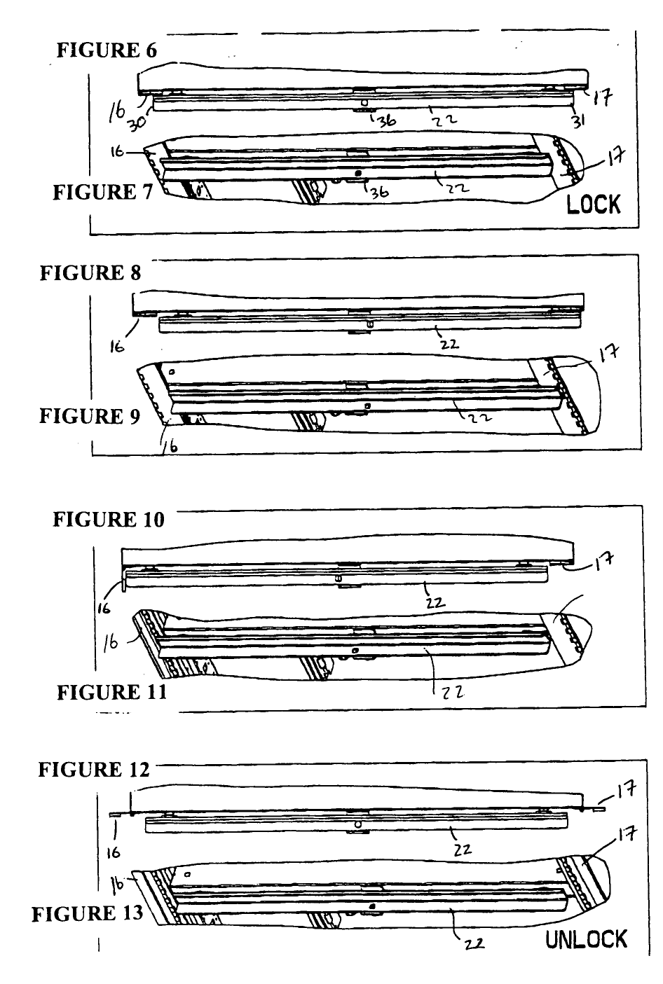

A locking bar 22 is slidably mounted to the forward facing surface 62 of the crossbeam 20 for sliding in the horizontal direction relative the crossbeam 20. FIGS. 2, 6 and 7 show a middle locked position in which the locking bar 22 overlaps both of the blocking plates 16, 17 and prevents opening of the drawers. As seen in FIG. 6 which is a top view of FIG. 2, the left end 30 of the locking bar 22 is forward of the left blocking plate 16 and prevents its movement from the blocked position shown and the right end 31 of the locking bar 22 is forward of the right blocking plate 17 and prevents its movement from the blocked position.

The locking bar 22 is slidable from the position shown in FIG. 2to the right to the position shown in FIGS. 3, 8 and 9 such as to be clear of the blocking plate 16 thus allowing the blocking plate 16 to be rotated between the blocked and the unblocked position. FIGS. 4, 10 and 11 show a position which after the locking bar 16 has been rotated to the unblocked position, the locking bar 22 has been slid to the left to a position shown in FIG. 4 such as to be clear of blocking plate 17 thus allowing the blocking plate 17 to be rotated between the unblocked position and a blocked position. FIGS. 5, 12, 13 and 14 show a condition which from the position of FIG. 4, the blocking plate 17 is pivoted to the unblocked position and the locking bar 22 is slid back to the middle position. As seen in FIG. 12 in a top view the hinged blocking plates 16, 17 are in a position where they are out of the path of the drawers 60 and therefore, do not prevent the opening of the drawers 60, as shown in FIG. 29 with one drawer open.

The length of locking bar 22 is such that when it is slid to the right, as shown in FIG. 3, the left end 30 of the locking bar 22 is clear of the blocking plate 16 on the left side of the filing cabinet 10, and the right end 31 of the locking bar 22 does not extend past the edge of side wall 13. Similarly, when the locking bar 22 is slid to the left, as shown in FIG. 4, the right end 31 of the locking bar 22 is clear of the blocking plate 17 on the right side of the filing cabinet 10, and the left end 30 of the locking bar 22 does not extend past the edge of side wall 12. Therefore, the locking bar 22 is designed such that it does not extend laterally past vertical planes of the side walls 12 and 13 of the filing cabinet 10, and does not move into, for example, a wall adjacent the filing cabinet 10 or into the path of the drawers of any other filing cabinets which are adjacent to filing cabinet 10.

In the middle locked position of FIGS. 2, 6 and 7, the locking bar 22 is adapted to be fixed in the position to prevent movement of the locking bar 22. In this regard as best seen in FIG. 6 and 7, a lock bracket 36 is secured to a central portion of the crossbeam 20 providing a horizontally extending flange with a vertical opening therethrough which is to align with vertical opening in the lock bar 22 such that a locking device such as a padlock may lock the locking bar 22 to the crossbeam 20 against movement. The locking bar 22 shown in FIGS. 1 to 13 has a L-shaped in cross-section with one flange vertical and the other flange horizontal. The horizontal flange carries the vertical opening to receive a padlock.

As seen, for example, in FIG. 29, the locking bar 22 has a vertical extent which is not greater than the vertical extent of the crossbeam 20 such that with the locking bar 22 itself doe not interfere with movement of the drawers 60 on either side of the crossbeam 20 to an open extended position.

### Second Preferred Embodiment

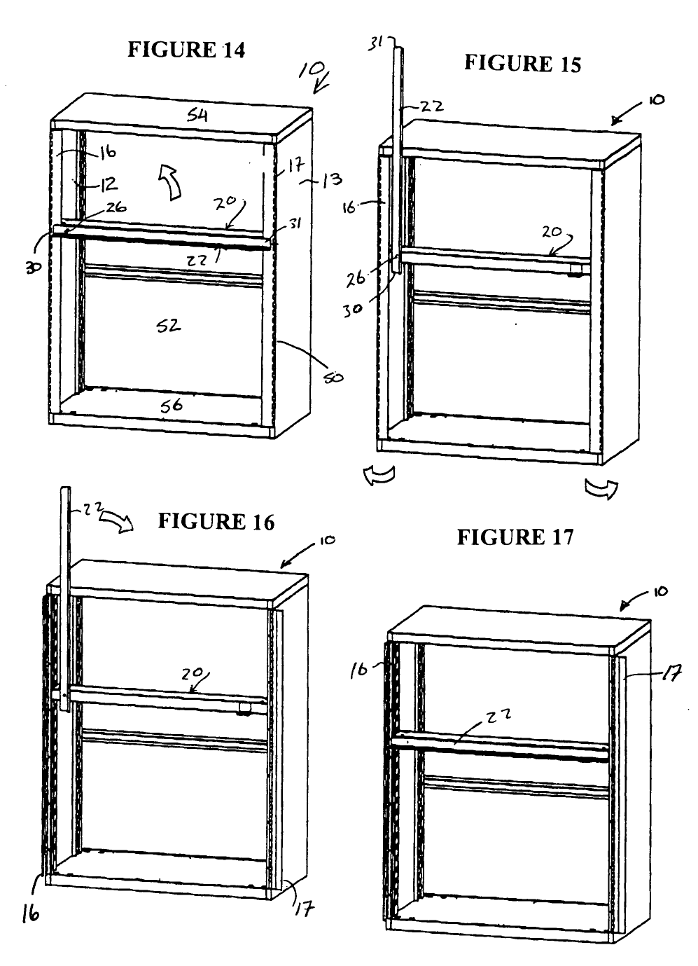

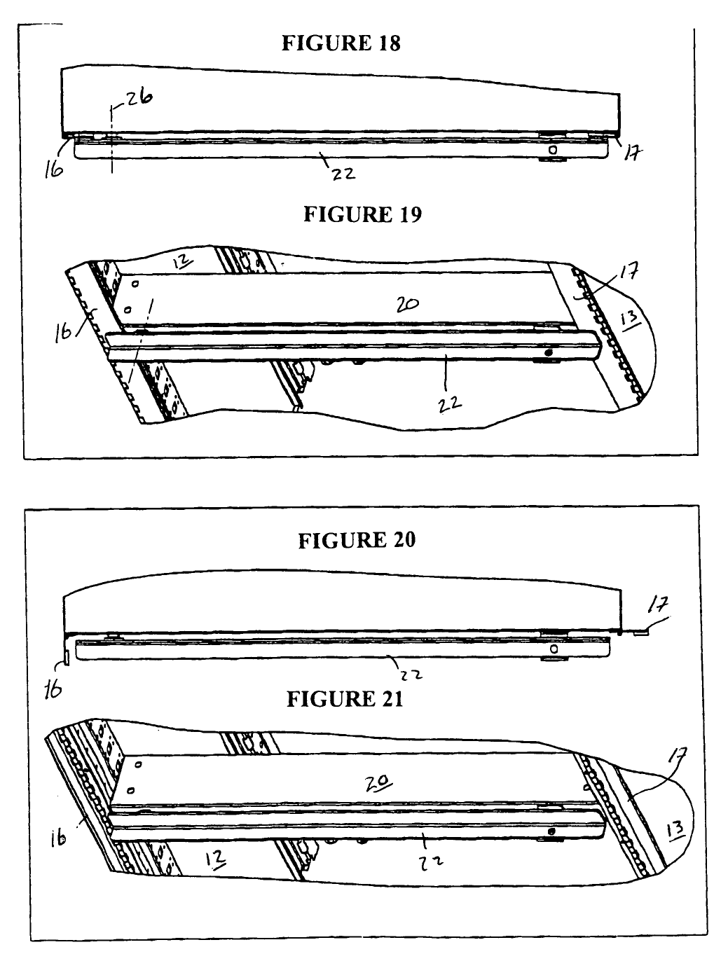

FIGS. 14 to 24 illustrate a second embodiment of the filing cabinet 10 of the present invention in which the drawers and associated slides have been removed.

In this embodiment, the locking bar 22 is pivotally mounted to the crossbeam 20 for pivoting about an axis or pivot indicated generally as 26. This configuration allows for pivoting of the locking bar 22 between: (i) a horizontal position in which it overlies the crossbeam 20, as seen in FIGS. 14 and 17; and (ii) a vertical position parallel to side wall 13, as seen in FIGS. 15 and 16. The locking bar 22 is spaced forwardly from the crossbeam 20 such that each blocking plate 16, 17 may be received in a space between the locking bar 22 and the crossbeam 20.

In the locked position illustrated in FIGS. 14, 18, 19 and 22, the blocking plates 16 and 17 are in a blocked position forward of the drawers and extending in the front plane of the front face of the cabinet 10. Referring first to the left side, the locking bar 22 is in a horizontal position in which the end 30 of the locking bar 22 is forward of and overlaps the blocking plate 16 on the left side of the cabinet 10. Thus the locking bar 22 prevents the blocking plate 16 from being moved from the blocked position to the unblocked position. The locking bar 22 does not extend laterally past the side wall 12 of the filing cabinet.

Referring to the right side, the length of the locking bar 22 is such that in the position shown in FIG. 14, the left end 31 of the locking bar 22 is forward of and overlaps the blocking plate 17 on the right side of the filing cabinet 10. Thus the locking bar 22 prevents blocking plate 17 from being moved from the blocked position to the unblocked position. The locking bar 22 does not extend laterally past side wall 13 of the filing cabinet 10.

From the position of FIG. 14, the locking bar 22 has been pivoted about pivot pin 26 to a vertical position parallel to sidewall 14 as shown in FIG. 15. In this vertical position, the locking bar 22 does not prevent the blocking plates 16 and 17 on either side of the cabinet 10 from being moved from the blocked position to the unblocked position, and the blocking plates 16 and 17 are each able to be moved between the blocked and unblocked positions. FIG. 16 shows a condition in which from the position of FIG. 15, the blocking plates 16 and 17 have been moved to the unblocked position shown in FIG. 16 with the locking bar maintained vertical. The locking bar 22 is pivotally connected to the crossbeam 20 at pivot axis 26 with the pivot pin 26 is spaced inwardly from an end 30 of the locking bar 22 sufficiently that when the locking bar 22 is in the vertical position shown in FIGS. 15 and 16 the locking bar 22 is spaced laterally inwardly from the blocking plate 16 as in necessary that the blocking plate 16 be free to pivot between the blocked and unblocked positions. From the position of FIG. 16 the locking bar 22 can be pivoted about the pivot pin 26 to assume the horizontal position shown in FIGS. 17, 20 and 21 with the blocking plates 16, 17 in the unblocked position and extending forwardly parallel to the side walls 12 and 13 of the cabinet. In the position of FIGS. 17, 20 and 21, the blocking plates 16, 17 are out of the path of the drawers and do not prevent the drawers from being withdrawn and retracted.

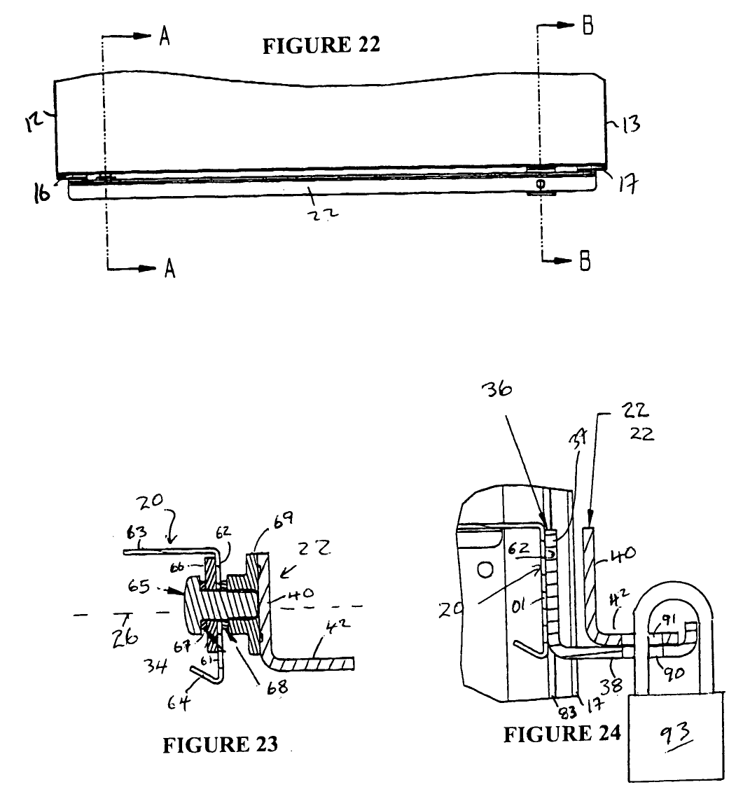

FIG. 23 is a cross-sectional view along section line A-A of FIG. 22 showing a preferred configuration by which the locking bar 22 is pivotally mounted to the crossbeam 20 for pivoting about pivot axis 26. The locking bar 22 is L-shaped is cross-section having vertical leg 40 and horizontal leg 41. The crossbeam 20 has a vertical portion 61 presenting a forward face 62. A top flange 63 and a bottom flange 64 extending rearwardly from the vertical portion 61. At the location of pivot axis 26, a strengthening plate 66 is secured to the rear of the vertical portion 61. A screw 65 carrying washers 67 and 68 extends through an aperture the plate 66 and the vertical portion 61 and into a threaded nut 69 welded to a rear of the vertical leg 40 of the locking bar 22.

FIG. 24 is a cross-sectional view along section line B-B of FIG. 22 illustrating a lock bracket 36 which is fixedly secured to the crossbeam 20 by reason of a vertical leg 37 being welded to the vertical portion 61 of the crossbeam 20 to present a horizontal leg 38 projecting forwardly. The locking bar 22 is shown with its horizontal leg 42 resting on the horizontal leg 38 of the lock bracket 36. Vertical openings 90 and 91 in through the horizontal leg 30 of the lock bracket 36 and the horizontal leg 42 of the locking bar 22 align to receive a padlock 93 or other locking mechanism to lock the locking bar 22 against movement relative to the crossbeam 20 and, therefore, to secure the hinged blocking plates 16 in the closed position shown in FIGS. 14, 18, 19, 22 and 24. FIG. 24 shows the blocking plate 17 as disposed in a blocked position rearward of the locking bar 22.

In FIG. 14 to 24 the pivot axis 26 is show as located proximate to one side of the cabinet 10. This is preferred but not necessary and the pivot axis 26 could be in the centre middle of the crossbeam between two sides.

### Third Preferred Embodiment

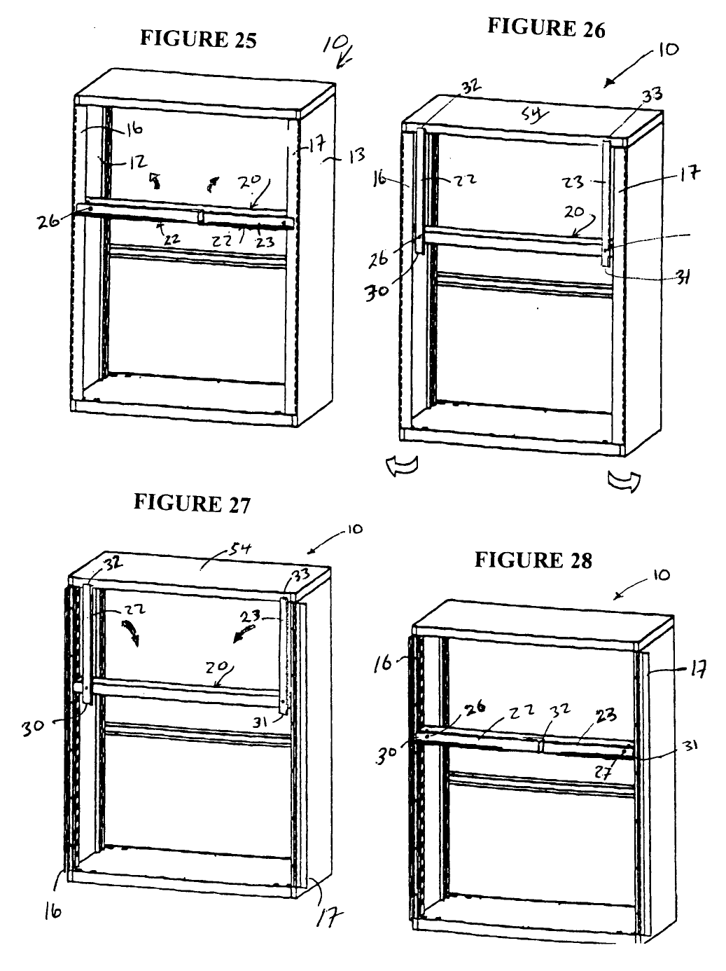

FIGS. 25 to 28 illustrate a third embodiment of the filing cabinet 10 of the present invention. The drawers and associated slides have been removed.

The third preferred embodiment is a variation of the second embodiment illustrated in FIGS. 14 to 24. In the third embodiment, however, there are two separate locking bars 22 and 23. Each locking bar 22, 23 is pivotally mounted opposite ends of the crossbeam 20 by a pivot mechanism for pivoting about pivot axis 26 and 27.

In a horizontal position, as shown in FIG. 25, both locking bars 22, 23 overlie the crossbeam 20. The ends 32, 33 of the locking bars 22, 23 which are farthest away from the pivot axes 26, 27 overlap in the middle of the cabinet where they can be secured, as preferably to the crossbeam 20 for locking as with a padlock and locking bracket, not shown, but similar to that in FIG. 24. In FIG. 25, the blocking plates 16, 17 are in a blocked position extending in the front plane of the front face of the cabinet 10 and each locking bar 22, 23 is in a horizontal position with the end 30, 31 of the locking bar 22 that is nearer to pivot axes 26, 27 in front of one of the blocking plates 16, 17 to prevent the blocking plate 16, 17 from being moved from a blocked position to an unblocked position.

The length of each of the locking bars 22, 23 is such that when the locking bars 22 are in the horizontal position shown in FIG. 25, the near ends 30, 31 overlap the blocking plates 16, 17 but do not extend past either of the side walls 12 and 13.

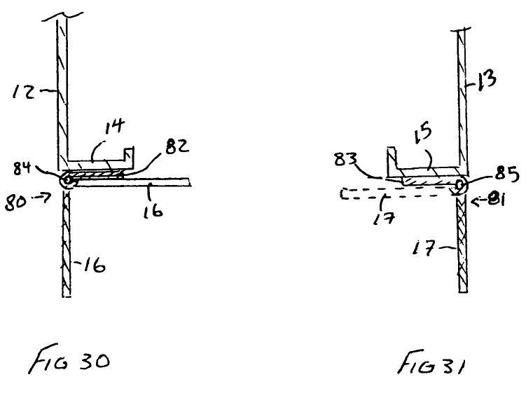

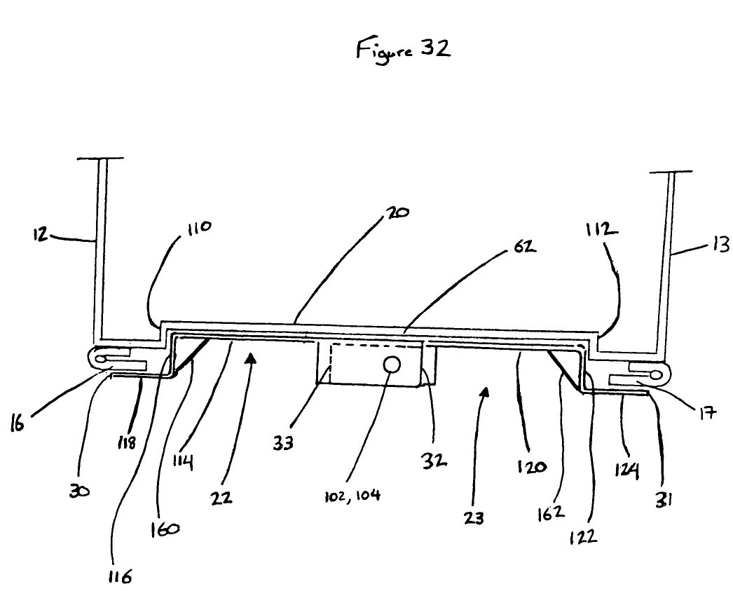

In FIGS. 26 and 27, both of the locking bars 22, 23 have been pivoted about their pivot axes 26, 27 to a vertical position parallel to side walls 12 and 13. In this vertical position, neither of the locking bars 22, 23 prevent the blocking plates 16, 17 from being moved from the blocked position to the unblocked position. FIG. 28 illustrates a position in which from the position of FIG. 27, the locking bars 22, 23 are pivoted to a horizontal position. In the position of FIG. 28 the drawers 60 may be opened.

In the third embodiment, when the locking bars 22, 23 are in the vertical position shown in FIGS. 26 and 27, the length of the locking bars 22, 23 are limited such that the far ends 32, 33 of the locking bars 22 do not extend upwardly past top wall 54.

While the second and third embodiments have been illustrated with the locking bars 22, 23 moved to a vertical position extending upwardly from the pivot axis 26, 27 to permit the blocking plates 26, 27 to be moved between the blocked and unblocked positions, the locking bars 22, 23 could be moved to vertical position with the locking bars 22, 23 extending downwardly from the pivot axis 26, 27 provided sufficient vertical spacing is available above a floor on which the cabinet rests.

### Fourth Preferred Embodiment

FIGS. 32 to 35 illustrate a fourth preferred embodiment of the filing cabinet 10 of the present invention.

The fourth preferred embodiment has elements of both the first preferred embodiment illustrated in FIGS. 1 to 13 and 29 and the third preferred embodiment illustrated in FIGS. 25 to 28.

Similar to the third preferred embodiment, the fourth preferred embodiment has two separate locking bars, a left locking bar 22 and a right locking bar 23. Like the first preferred embodiment, each locking bar 22, 23 of the fourth preferred embodiment is slidably mounted to the forward facing surface 62 of the crossbeam 20 for sliding in the horizontal direction relative to the crossbeam 20.

FIGS. 34 and 35 provide isolated views of the left locking bar 22 and the right locking bar 23, respectively.

As shown in FIGS. 34 and 35, each locking bar 22, 23 is divided into three portions. For example, the left locking bar 22 divided into a main portion 114, a shoulder portion 116, and an end portion 118. The main portion 114 is substantially parallel to the crossbeam 20 of the filing cabinet 10. The left locking bar 22 is bent at a substantially right angle to the main portion 114 in order to form the shoulder portion 116. Therefore, the shoulder portion 116 is substantially perpendicular to both the main portion 114 and the crossbeam 20. The left locking bar 22 is then bent again at a substantially right angle to the shoulder portion 116 in order to form the end portion 118. Therefore, the end portion 118 is substantially parallel to both the main portion 114 and the crossbeam 20.

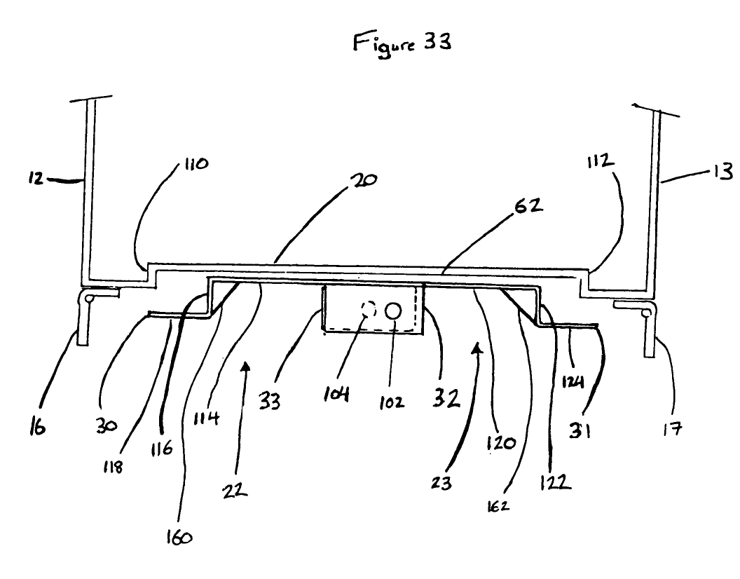

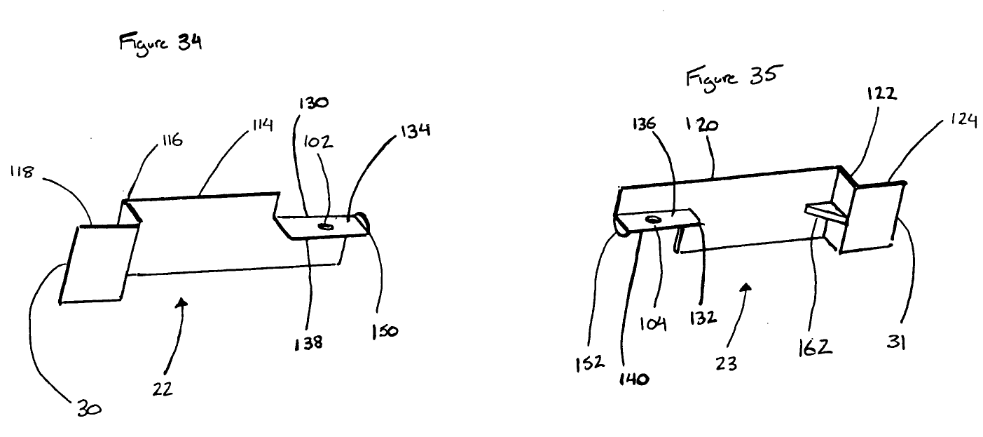

The right locking bar 23 is almost a mirror image of the left locking bar 22. The right locking bar 23 is divided into a main portion 120, a shoulder portion 122, and an end portion 124. The main portion 120 is substantially parallel to the crossbeam 20 of the filing cabinet 10. The right locking bar 23 is bent at a substantially right angle to the main portion 120 in order to form the shoulder portion 122. Therefore, the shoulder portion 122 is substantially perpendicular to both the main portion 120 and the crossbeam 20. The right locking bar 23 is then bent again at a substantially right angle to form to the shoulder portion 122 in order to form the end portion 124. Therefore, the end portion 124 is substantially parallel to both the main portion 120 and the crossbeam 20. A right reinforcement bracket 162 is placed between the main protion 120 and the shoulder portion 122. The reinforcement bracket 162 maintains the substantially right angle between the main portion 120 and the shoulder portion 122. Therefore, the reinforcement bracket 162 prevents the right locking bar 23 from being manually bent or pried away from its position forward of the right blocking plate 17. A corresponding left reinforcement bracket 160 for the left locking bar 22 is shown in FIGS. 32 and 33.

FIG. 32 shows a locked position of the fourth preferred embodiment. The left locking bar 22 is in a left most position, such that the left end 30 of left locking bar 22 is forward of the left blocking plate 16 and prevents its movement from the blocked position shown. Similarly, the right locking bar 23 is in a right most position, such that the right end 31 of the right locking bar 23 is forward of the right blocking plate 17 and prevents its movement from the blocked position shown.

The left locking bar 22 is designed such that when it is in the left most position shown in FIG. 32, the left shoulder portion 116 abuts with a corresponding shoulder portion 110 formed in crossbeam 20. The corresponding shoulder portion 110 of the crossbeam 20 is similar to the left shoulder portion 116 in that both of these structures are defined by two substantially right angle bends. The left locking bar 22 is prevented from sliding any further to the left. As such, the left end 30 of the left locking bar 22 does not extend past the edge of side wall 12. Similarly, the right locking bar 23 is designed such that when it is in the right most position shown in FIG. 32, the right shoulder portion 122 abuts with a corresponding shoulder portion 112 formed in crossbeam 20. The corresponding shoulder portion 112 of the crossbeam 20 is similar to the right shoulder structure 122 in that both of these structures are defined by two substantially right angle bends. The right locking bar 22 is prevented from sliding any further to the right. As such, the right end 31 of the right locking bar 23 does not extend past the edge of side wall 13. Therefore, the locking bars 22, 23 are designed such that they do not extend laterally past the vertical planes of side walls 12, 13 of the filing cabinet 10.

Tabs 130, 132 are formed adjacent the far ends 32, 33 of each locking bar 22, 23. Each tab 130, 132 is bent at a substantially right angle to the main portion 114, 120 such that the tab 130, 132 lies in the horizontal plane. Each tab 130, 132 has a top surface 134, 136 and a bottom surface 138, 140. Vertical openings 102, 104 extend from the top surface 134, 136 of the tabs 130, 132 through to the bottom surface 138, 140 of the tabs 130, 132. Preferably, the vertical opening 102 in the left locking bar 22 has the same size and shape as the vertical opening 104 in the right locking bar 23. The size and shape of the vertical openings 102, 104 is not particularly limited, but should be designed such that a padlock can be received through said vertical openings 102, 104.

When in the locked position shown in FIG. 32, the vertical opening 102 of the left locking bar 22 is aligned with the vertical opening 104 of the right locking bar 23. When desired, a locking mechanism, such as a padlock, can be inserted through both openings 102, 104 and secure both locking bars 22, 23 in the locked position.

Preferably, the ends 32, 33 of the locking bars 22, 23 form finger gripping means, as shown in FIGS. 34 and 35. This allows a user to grasp the ends 32, 33 and manually slide each locking bar 22, 23 in the horizontal direction.

FIG. 33 illustrates an unlocked position of the fourth preferred embodiment. The left locking bar 22 is slidable from the left most position shown in FIG. 32 to a right most position shown in FIG. 33, such that the left end 30 of the left locking bar 22 is laterally inwardly of the left blocking plate 16 and the left blocking plate 16 is free to be rotated between the blocked and the unblocked positions. The right locking bar 23 is slidable from the right most position shown in FIG. 32 to a left most position shown in FIG. 33, such that the right end 31 of the right locking bar 23 is laterally inwardly of the right blocking plate 17 and the right blocking plate 17 is free to be rotated between the blocked and the unblocked positions.

Each of the embodiments show a filing cabinet with a crossbeam 20 which is preferred but not necessary. The sliding locking bar 22 of FIG. 1 could be mounted to one or both of the gable-like crossbeams 95 and 96 forward as part of and adjacent top wall 10 and bottom wall 56. The pivoting licking bars 22, 23 of FIGS. 14 to 25 could similarly be mounted to the top crossbeam 95 and possibly the bottom crossbeam 96.

The continuous hinges forming the blocking plates 16, 17 are shown in each embodiment to extend the entire height of the cabinet 10. This is not necessary but preferred. The hinges need to only extend adjacent a portion of each drawer 60 whose opening is to be blocked.

Although this disclosure has described and illustrated preferred embodiments of the invention, it is to be understood that the invention is not restricted to these particular embodiments. Rather, the invention includes all embodiments that are functional or mechanical equivalents of the specific embodiments and features that have been described and illustrated herein. Many modifications and variations will now occur to those skilled in the art. For a definition of the invention, reference is made to the following claims.

We claim:

1. A filing cabinet comprising:
a framework having two opposite side walls, a top wall and a bottom wall defining a compartment therein having a forward opening;
at least one drawer slidably mounted in said compartment for sliding between withdrawn position inside the compartment and a extended position in which the drawer extends out of the opening;
a right blocking plate and a left blocking plate each hinged to the framework on the opposite side of said opening, wherein each of said blocking plates is pivotable on a vertical axis between: (i) a blocked position in the path of the drawer to prevent the drawer from withdrawal from the retracted position; (ii) an unblocked position out of the path of the drawer to permit withdrawal to the withdrawn position;
a locking bar mounted to said framework, wherein said locking bar is movable between: (i) a locked position where at least a portion of said locking bar is in the path of both of said blocking plates and prevents both blocking plates from movement between the blocked position to the unblocked position; (ii) an unlocked position where said locking bar is out of the path of the right blocking plate and does not prevent the right blocking plate from movement from the blocked position to the unblocked position; and (iii) an unlocked position where said locking bar is out of the path of the left blocking plate and does not prevent the left blocking plate from movement from the blocked position to the unblocked position;
a locking mechanism to releasably lock the locking bar in the locked position.

2. A filing cabinet according to claim 1, wherein said framework includes a crossbeam which has ends that are secured to said two opposite side walls, and wherein said locking bar is mounted to said crossbeam.

3. A filing cabinet according to claim 2, wherein said locking bar is slidably mounted to said crossbeam, for horizontal sliding movement between (i) a left most position in which a right side end of the locking bar is laterally inwardly of a the right blocking plate such that the right blocking plate is free to be pivoted between the blocked and the unblocked positions; (ii) a right most position in which a left side end of the locking bar is laterally inwardly of a the left blocking plate such that the left blocking plate is free to be pivoted between the blocked and the unblocked positions; (iii) a centre position in which each of the right side end and the left side end of the locking bar prevent the right blocking plate and the left blocking plate, respectively, from being pivoted between the blocked and the unblocked positions.

4. A filing cabinet according to claim 2, wherein said locking bar is pivotally mounted to said crossbeam for pivoting about a horizontal axis between (i) a horizontal position in which the locking bar overlies the crossbeam and the left and right ends of the locking bar extend laterally sufficiently to prevent pivoting of the left and right blocking plates between the blocked and unblocked positions; and (ii) a non-horizontal position in which each of the left and rights ends of the locking bar are spaced laterally inwardly of the right and left blocking plates respectively such that both the right and left blocking plates are free to be pivoted between the blocked and unblocked positions.

5. A filing cabinet according to claim 3, wherein said crossbeam has a forward facing surface and said locking bar is mounted to said forward facing surface of said crossbeam.

6. A filing cabinet according to claim 4, wherein said crossbeam has a forward facing surface and said locking bar is mounted to said forward facing surface of said crossbeam.

7. A filing cabinet according to claim 1, wherein said two opposite side walls each have a forward facing gable surface, wherein a continuous hinge having a first hinge plate and a second hinge plate pivotable about a hinge pin has the first hinge plate mounted to said forward facing gable surface of said side wall and wherein the second hinge plate comprises one of said blocking plates,
the continuous hinge extending vertically adjacent each drawer whose opening is to be blocked.

8. A filing cabinet according to claim 3, wherein said two opposite side walls each have a forward facing gable surface, wherein a continuous hinge having a first hinge plate and a second hinge plate pivotable about a hinge pin has the first hinge plate mounted to said forward facing gable surface of said side wall and wherein the second hinge plate comprises one of said blocking plates,
the continuous hinge extending vertically adjacent each drawer whose opening is to be blocked.

9. A filing cabinet according to claim 4, wherein said two opposite side walls each have a forward facing gable surface, wherein a continuous hinge having a first hinge plate and a second hinge plate pivotable about a hinge pin has the first hinge plate mounted to said forward facing gable surface of said side wall and wherein the second hinge plate comprises one of said blocking plates,
the continuous hinge extending vertically adjacent each drawer whose opening is to be blocked.

10. A filing cabinet according to claim 3, wherein in sliding between the leftmost position and the rightmost position the locking bar does not extend laterally farther than either of the side walls.

11. A filing cabinet according to claim 4, wherein in pivoting between the horizontal position and the non-horizontal position the locking bar does not extend laterally farther than either of the sidewalls.

12. A filing cabinet as claimed in claim 10, wherein in pivoting between blocked and unblocked positions each blocking plate does not extend laterally farther than either of the side walls.

13. A filing cabinet as claimed in claim 11, wherein in pivoting between blocked and unblocked positions each blocking plate does not extend laterally farther than either of the side walls.

14. A filing cabinet comprising:
a framework having two opposite side walls, a top wall and a bottom wall defining a compartment therein having a forward opening;
at least one drawer slidably mounted in said compartment for sliding between withdrawn position inside the compartment and a extended position in which the drawer extends out of the opening;
a right blocking plate and a left blocking plate each hinged to the framework on the opposite side of said opening, wherein each of said blocking plates is pivotable on a vertical axis between: (i) a blocked position in the path of the drawer to prevent the drawer from withdrawal from the retracted position; (ii) an unblocked position out of the path of the drawer to permit withdrawal to the withdrawn position;
a right locking bar and a left a locking bar each mounted to said framework,
the right locking bar is movable between: (i) a locked position where at least a portion of the right locking bar is in the path of the right blocking plate and prevents the right blocking plates from movement between the blocked position to the unblocked position; (ii) an unlocked position where said right locking bar is out of the path of the right blocking plate and does not prevent the right blocking plate from movement from the blocked position to the unblocked position;
the left locking bar is moveable between: (i) a locked position where at least a portion of the left locking bar is in the path of the left blocking plate and prevents the left blocking plates from movement between the blocked position to the unblocked position;
(ii) an unlocked position where said left locking bar is out of the path of the right blocking plate and does not prevent the right blocking plate from movement from the blocked position to the unblocked position.

15. A filing cabinet according to claim 14, wherein said framework includes a crossbeam which has ends that are secured to said two opposite side walls, and wherein said right locking bar and said left locking bar are mounted to said crossbeam.

16. A filing cabinet according to claim 15, wherein said right locking bar and said left locking bar are slidably mounted to said crossbeam,
the right locking bar having horizontal sliding movement between (i) a leftmost position in which a right side end of the right locking bar is laterally inwardly of the right blocking plate such that the right blocking plate is free to be pivoted between the blocked and the unblocked positions; and (ii) a rightmost position in which the right side end of the right locking bar prevents the right blocking plate from being pivoted between the blocked and the unblocked positions; and
the left locking bar having horizontal sliding movement between (i) a rightmost position in which a left side end of the left locking bar is laterally inwardly of the left blocking plate such that the left blocking plate is free to be pivoted between the blocked and the unblocked positions; and (ii) a leftmost position in which the left side end of the left locking bar prevents the left blocking plate from being pivoted between the blocked and the unblocked positions.

17. A filing cabinet according to claim 16, further comprising a locking mechanism to releasably lock the right locking bar in the rightmost position and the left locking bar in the leftmost position.

18. A filing cabinet according to claim 15, wherein said right locking bar and said left locking bar are pivotally mounted to said crossbeam
the right locking bar being pivotable about a horizontal axis between (i) a horizontal position in which the right locking bar overlies the crossbeam and a right side end of the right locking bar extends laterally sufficiently to prevent pivoting of the right blocking plate between the blocked and unblocked positions; and (ii) a non-horizontal position in which the right side end of the right locking bar is spaced laterally inwardly of the right blocking plate such that the right blocking plate is free to be pivoted between the blocked and unblocked positions; and
the left locking bar being pivotable about a horizontal axis between (i) a horizontal position in which the left locking bar overlies the crossbeam and a left side end of the left locking bar extends laterally sufficiently to prevent pivoting of the left blocking plate between the blocked and unblocked positions; and (ii) a non-horizontal position in which the left side end of the left locking bar is spaced laterally inwardly of the left blocking plate such that the left blocking plate is free to be pivoted between the blocked and unblocked positions.

19. A filing cabinet according to claim 18, further comprising a locking mechanism to releasably lock the right locking bar and the left locking bar in the horizontal position.
